(19) United States
(12) Patent Application Publication
(10) Pub. No.: US 2008/0285291 A1
(43) Pub. Date: Nov. 20, 2008

(54) Recessed light retrofit kit

(76) Inventor: Gregory L. Fornari, Shelby Township, MI (US)

Correspondence Address: Thomas Randazzo, 273 Eckford Dr., Troy, MI, 48085, US

(21) Appl. No.: 11/803,234

(22) Filed: May 14, 2007

(51) Int. Cl. F21S 8/04; F21V 21/088; H01J 9/00

(52) U.S. Cl. 362/396; 362/404; 445/23

(57) ABSTRACT

A kit and method is disclosed to convert a recessed incandescent lighting fixture to a hanging light fixture. The kit includes a lampholder adapter, an electrical plug, an electrical plug, a power cord and a cover plate for hanging light fixtures using incandescent light bulbs. There is also disclosed a kit to convert a recessed incandescent lighting fixture to a hanging light fixture that uses halogen light bulbs. The kit includes a lampholder adapter, an electrical plug, an electronic ballast, a power cord, an adjustable lamp cord, and a cover plate.

### TECHNICAL FIELD

This disclosure is directed to retrofit units for recessed lighting fixtures and to retrofit units which permit hanging light fixtures that use incandescent or halogen light bulbs to replace recessed lighting fixtures that use incandescent light bulbs in a recessed lighting fixture housing.

### BACKGROUND

There are many types of lighting fixtures that are known in the art. Lighting fixtures are defined to include those types of lighting elements that are attached or fixed to a housing that is built into or otherwise located in a wall or ceiling, as distinguished from free-standing lamps. Lighting fixtures typically include recessed lighting fixtures, hanging light fixtures, hanging light fixtures, track-lighting fixtures, and the like.

Lighting fixtures are attached or fixed to a housing that is built into or otherwise located in a wall or ceiling. Lighting fixtures require both mechanical and electrical connections to the housing. The housing usually contains electrical wires that connect the wires of the lighting fixture to the electrical system wiring of the home or building. The housing is typically mounted above the ceiling panels, or within the walls, and electrical system wiring for connection to the lighting fixture wires, as well as components for securely mounting the housing to ceiling beams or other structural building elements, are contained within or on the housing. In this manner, in addition to providing a source of electrical power to a lighting fixture, the housing can be used to attach and support a lighting fixture so that the lighting fixture is securely held in place.

Recessed lighting fixtures and hanging light fixtures are both routinely utilized in residential and commercial buildings to provide room lighting and a decorative accent. Recessed lighting fixtures are lighting fixtures which are recessed into a ceiling such that, excepting for a portion of the bulb and a trim piece, no portion of the lighting fixture is seen below the plane of the ceiling. Lighting fixtures of this type, also known as “can lights” or “can fixtures,” are well known in both new construction and in retrofit situations due, in part, to the unobtrusive nature of the fixtures themselves and of their desirable illumination pattern. Recessed lighting fixtures are typically connected directly to the electrical wiring system without the use of an electrical junction box because the housing canister of the recessed lighting fixture occupies the same space that would be occupied by an electrical junction box.

Hanging light fixtures are distinguishable from recessed lighting fixtures in two respects. First, a hanging light fixture extends below the plane of the ceiling while a recessed lighting fixture does not. Second, the bulb in a recessed lighting fixture is positioned directly inside the housing while in a hanging light fixture the bulb is not inside the housing. Additionally, a single hanging light fixture may have multiple bulbs, such as in a chandelier, whereas a recessed lighting fixture contains a single bulb.

Hanging light fixtures require an electrical junction box that is typically located above the ceiling panels and electrical wiring for connection to the hanging light fixture is contained within the junction box. The junction box also contains elements for attaching the hanging light fixture to the junction box to give the appearance that it is attached to the ceiling. Hanging light fixtures include any lighting fixture that has the appearance of being attached to the ceiling, including those lighting fixtures that have chains, cords, or cables that are used to lower the lighting element away from the ceiling, such as a chandelier.

Hanging light fixtures can be easily changed to be updated to more modern lighting fixtures or to accommodate a particular design theme in a room. The light pattern from a hanging light fixture creates an entirely different mood and atmosphere than the light pattern from a recessed lighting fixture. Hanging light fixtures are readily interchangeable and can be changed out relatively easily when updating or remodeling a room. However, if a room has recessed fighting fixtures, there are times when it would be desirable to change a recessed lighting fixture to a hanging light fixture to create a different mood or appearance in the room.

Recessed lighting fixtures provide desirable function and operation. However, when it is desired to change the lighting aesthetics, recessed light may no longer be desirable for the room. The expenditure involved in replacing recessed lighting fixtures is considerable. Thus, it is desirable to be able to convert recessed lighting fixtures, preferably in situ, to use hanging light fixtures.

Converting a recessed lighting fixture to a hanging light fixture is a formidable task and one that has typically been undertaken only by a professional or a very confident handyman. The conversion typically includes removing the recessed lighting fixture from the ceiling and installing a junction box. Then the hanging light fixture needs to be connected to the junction box, both electrically and mechanically. Typically, the ceiling will have to be repaired because the opening in the ceiling for the recessed light is usually larger than the opening required for the junction box, which may require a drywall repair for drywall ceilings.

As can be appreciated, this conversion can be very costly due to the labor to remove the recessed lighting fixture, the expense associated with installing a junction box for each recessed lighting fixture, and the cost to repair the ceiling, not to mention the clean-up that must take place after the conversion.

From the foregoing, it would be desirable to have a recessed lighting fixture retrofit kit that can be easily employed to convert a recessed lighting fixture to accommodate hanging light fixtures. It would also be desirable to have a recessed lighting fixture retrofit kit that converts a recessed lighting fixture to a hanging lighting fixture that uses either an incandescent bulb or a halogen bulb.

### SUMMARY

Disclosed herein is a recessed light retrofit kit that satisfies these needs. Heretofore, there has not been a recessed light retrofit kit that could be easily be used to convert a recessed lighting fixture to a hanging light fixture.

The disclosure herein is directed to a recessed lighting fixture retrofit kit to convert a recessed lighting fixture to accommodate a hanging light fixture that includes a screw-in lampholder adapter, an electrical plug, and a cover plate. There is also disclosed a recessed lighting fixture retrofit kit to convert a recessed lighting fixture to accommodate a halogen lighting fixture that includes a screw-in lampholder adapter, an electrical plug, a transformer attaching clip, and a cover plate.

While the various embodiments of the disclosure are described with reference to a recessed lighting fixture retrofit kit to enable a recessed light fixture to be converted to accommodate hanging light fixtures using either incandescent or halogen light bulbs, it is to be understood that there may be combinations of equipment and methods that could be used to convert a recessed lighting fixture to accommodate hanging light fixtures that use either incandescent or halogen light bulbs. There is no recessed lighting fixture retrofit kit with the disclosed components that is capable of converting a recessed lighting fixture to accommodate hanging light fixtures that use either incandescent or halogen light bulbs. Other applications and advantages of such a recessed lighting fixture retrofit kit will become immediately obvious to one skilled in the art.

### DESCRIPTION OF THE DRAWINGS

FIG. 1 is a front elevation view in partial section of a recessed lighting fixture showing an incandescent light bulb positioned in an Edison-type lampholder.

FIG. 2 is a front elevation exploded view in partial section of a recessed lighting fixture converted to accommodate a hanging light fixture with an incandescent bulb.

FIG. 3 is a front elevation exploded view in partial section of a recessed lighting fixture converted to accommodate a hanging light fixture with a halogen bulb.

### DESCRIPTION

What is being disclosed is a recessed lighting fixture retrofit kit to convert a recessed lighting fixture to accommodate a hanging light fixture that includes a screw-in lampholder adapter, an electrical plug, and a cover plate. Other objects, advantages and applications will be best understood and become apparent from the following description of the various embodiments when read in connection with the accompanying drawings.

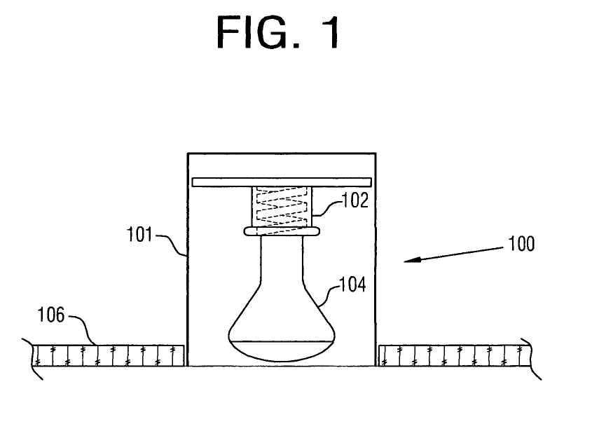

Referring now to FIG. 1, there is shown a recessed lighting fixture 100 that is known in the art. The recessed lighting fixture 100 includes a recessed light canister or can 101 which may be round, square or any other cross-sectional configuration. The most prevalent cans are cylindrical and about 6″-8″ in diameter and about 12″ in length. Typically, the can 101 is mounted to a beam or other structural building element (not shown) in the space above the ceiling 106. The can 101 is connected to the electrical system wiring through a junction box (not shown). A conventional Edison-type socket 102 is attached to the interior top end surface of the can 101. A conventional incandescent recessed light bulb 104 such as an indoor floodlight or other incandescent light bulb with Edison-type threads suitable for use in the recessed lighting fixture 100 is inserted into the Edison-type socket 102 located within the can 101.

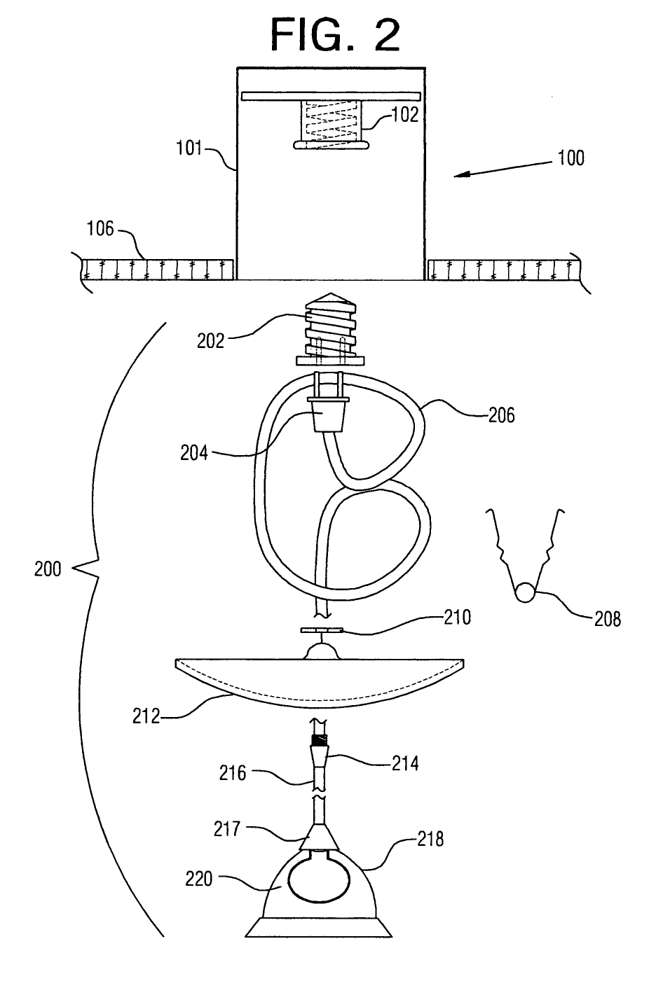

Referring to FIG. 2, there is shown a front elevation exploded view in partial section of recessed lighting fixture 100 converted to accommodate a hanging light fixture with an incandescent bulb 200. As disclosed herein, a retrofit hanging light fixture assembly 200 is designed to replace the incandescent recessed light source 104 (see FIG. 1) without any alteration of the existing can 101.

The hanging incandescent light fixture assembly 200 includes a threaded male Edison-end socket adapter 202 which is adapted to be threadedly engaged with the existing Edison-type socket 102. A male Edison-type electrical plug 204 is attached to a power cord 206 by screws or other suitable means. The power cord 206 passes through a retaining nut 210 and a cover plate 212. The cover plate 212 is round in the preferred embodiment and of sufficient diameter to completely cover the opening of the can 101. Because most cans are cylindrical and about 6″-8″ in diameter, in the preferred embodiment the diameter of the cover plate 212 is at least 8″ in diameter. The cover plate 212 can be fabricated from any suitable material, including plastic, aluminum, nickel, copper and the like. There is disclosed a spring clip 208 that has a loop end and two clip ends. In a preferred embodiment, at least two spring clips 208 are suitably attached to the cover plate 212 at their loop end and are suitably attached to the can 101 at their clip ends. The purpose of the spring clip 208 is to keep the cover plate 212 pulled snugly against the ceiling 106 to conceal the opening of the can 101.

Still with reference to FIG. 2, the power cord 206 is engaged with a cord retainer 214. In a preferred embodiment, the cord retainer 214 has a threaded end that passes through the cover plate 212 and is threadedly engaged with a retaining nut 210. The hanging light fixture assembly 200 can include an adjustable light cord 216 that allows for adjustment of the height of the incandescent lamp 220 above the area to be illuminated. The length of the adjustable light cord 216 depends, at least in part, on the height of the ceiling 106 of the facility above the floor. In many applications, it is expected that the adjustable light cord 216 will have a length of at least about 24″. Electric wires (not shown) within the adjustable light cord 216 provide power to the incandescent light bulb 220 from the power cord 206. An incandescent light socket 217 is connected to the adjustable light cord 216. A threaded collar (not shown) is connected to the incandescent light socket 217 and an incandescent light fixture reflector glass 218 is threadedly attached to the collar. An incandescent light bulb 220 is threadedly connected to the incandescent light socket 217.

In application, the conventional incandescent recessed light bulb 104 (FIG. 1) is threadedly removed from the can 101. The threaded male Edison-end socket adapter 202 (FIG. 2) is then threadedly engaged with the existing Edison-type socket 102 in the can 101. The male-end electrical plug 204 is suitably attached to the power cord 206. The male-end electrical plug 204 is inserted into socket adapter 202. The spring clips 208 are attached to the cover plate 212 at their loop end and are attached to the can 101 at their clip ends. The conversion from a recessed incandescent lighting fixture to a hanging lighting fixture with an incandescent light is readily completed.

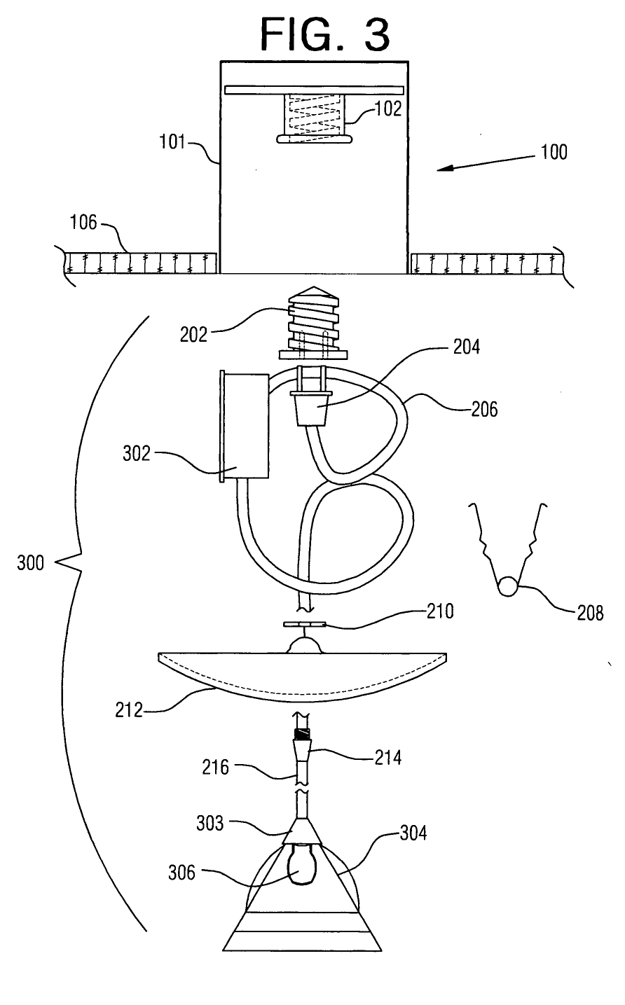

With reference to FIG. 3, there is disclosed another embodiment wherein the recessed lighting fixture 100 is converted to a hanging lighting fixture with a halogen bulb 300. The room aesthetics or simply personal preferences may dictate a halogen light source over an incandescent light source for the room lighting.

The hanging halogen light fixture assembly 300 includes a threaded male Edison-end socket adapter 202 which is adapted to be threadedly engaged with the existing Edison-type socket 102. A male-end electrical plug 204 is attached to a power cord 206 by screws or other suitable means. An electronic ballast 302 of suitable size and shape is electrically connected to the power cord 206. The electronic ballast 302 is, typically, fabricated in a plastic or metal case and measures about 4½″×2½″×1″. The electronic ballast 302 is attached to the can 101 by any suitable means such as screws, clips or the like. The power cord 206 passes through a retaining nut 210 and a cover plate 212. The cover plate 212 is round in the preferred embodiment and of sufficient diameter to completely cover the opening of the can 101. There is disclosed a spring clip 208 that has a loop end and two clip ends. In a preferred embodiment, at least two spring clips 208 are suitably attached to the cover plate 212 at their loop end and are suitably attached to the can 101 at their clip ends. The purpose of the spring clip 208 is to keep the cover plate 212 pulled snugly against the ceiling 106 to conceal the opening of the can 101.

Still with reference to FIG. 3, the power cord 206 is engaged with a cord retainer 214. In a preferred embodiment, the cord retainer 214 has a threaded end that passes through the cover plate 212 and is threadedly engaged with a retaining nut 210. The hanging halogen light fixture assembly 300 can include an adjustable light cord 216 that allows for adjustment of the height of the incandescent lamp 220 above the area to be illuminated. The length of the adjustable light cord 216 depends, at least in part, on the height of the ceiling 106 of the facility above the floor. In many applications, it is expected that the adjustable light cord 216 will have a distance of at least about 24 inches. Electric wires (not shown) within the adjustable light cord 216 provide power to the halogen lamp 306 from the power cord 206. A halogen lamp socket 303 is connected to the adjustable light cord 216. A threaded collar (not shown) is connected to the halogen lamp socket 303 and a halogen light fixture reflector glass 304 is threadedly attached to the collar. A halogen light bulb 220 is suitably connected to the halogen light socket 303.

In application, the conventional incandescent recessed light bulb 104 (FIG. 1) is threadedly removed from the can 101. The threaded male Edison-end socket adapter 202 (FIG. 3) is then threadedly engaged with the existing Edison-type socket 102 in the can 101. The electronic ballast 302 is attached to the can 101 by any suitable means such as screws, clips or the like. The male-end electrical plug 204 is inserted into socket adapter 202. The spring clips 208 attached to cover plate 212 at their loop end are attached to the can 101 at their clip ends. The conversion from a recessed incandescent lighting fixture to a hanging lighting fixture with a halogen light is readily completed.

It should be understood that the foregoing is illustrative of particular embodiments of the invention, and particular applications thereof, and it is not meant to be a limitation upon the invention in any way. In view of the disclosures presented herein, yet other variations of the kit being disclosed will be apparent to one of skill in the art. Any such modifications or variations which fall within the purview of the descriptions contained herein are intended to be included therein, as well. It is the following claims, including all equivalents, which define the scope of the invention.

What is claimed is:

1. A kit for converting a recessed lighting fixture to a hanging light fixture, said recessed lighting fixture comprising a housing for holding an incandescent bulb in an Edison-type socket operatively connected to a power network, said kit comprising:
(a) a screw-in lampholder adapter, the screw-in lampholder adapter operatively connected to an Edison-type socket in the recessed lighting fixture;
(b) an electrical plug, the electrical plug operatively connected to the screw-in lampholder adapter; and
(c) a cover plate, the cover plate suitably attached to the hanging light fixture and the housing of the recessed lighting fixture.

2. The kit for converting a recessed lighting fixture to a hanging light fixture of claim 1, further comprising at least one spring clip, the spring clip having a loop end and a clip end suitably attached to the cover plate at the loop end and the housing at the clip end.

3. The kit for converting a recessed lighting fixture to a hanging light fixture of claim 1, wherein the cover plate is between 8″ and 12″ in diameter.

4. A kit for converting a recessed lighting fixture to a hanging light fixture, said recessed lighting fixture comprising a housing for holding an incandescent bulb in an Edison-type socket with said socket operatively connected to a power network, said kit comprising:
(a) a screw-in lampholder adapter, the screw-in lampholder adapter operatively connected to the Edison-type lampholder socket in the recessed lighting fixture;
(b) an electrical plug, the electrical plug operatively connected to the screw-in lampholder adapter;
(c) a cover plate, the cover plate suitably attached to the hanging light fixture and the housing of the recessed lighting fixture; and
(d) a transformer attaching clip, the transformer attaching clip suitably attached to the housing of the recessed lighting fixture and a transformer for a hanging light fixture employing a halogen bulb.

5. A kit for converting a recessed lighting fixture to a hanging light fixture of claim 4, further comprising at least one spring clip, the spring clip having a loop end and a clip end with said spring clip suitably attached to the cover plate at the loop end and the housing at the clip end.

6. A kit for converting a recessed lighting fixture to a hanging light fixture of claim 4, wherein the cover plate is between 8″ and 12″ in diameter.

7. A method for converting a recessed lighting fixture to a hanging light fixture that uses incandescent bulbs comprising the steps of:
(a) removing a light bulb from an Edison-type lampholder socket in the recessed lighting fixture;
(b) installing a screw-in lampholder adapter into the Edison-type lampholder socket in the recessed lighting fixture;
(c) attaching an electrical plug to the hanging light fixture;
(d) inserting the electrical plug into the screw-in lampholder adapter in the recessed lighting fixture; and
(e) attaching a cover plate by suitably engaging at least one spring clip to the housing of the recessed lighting fixture.

8. The method defined by claim 7, wherein the cover plate is engaged with the housing of the recessed lighting fixture by two spring clips suitably attached to the housing of the recessed lighting fixture.

9. A method for converting a recessed lighting fixture to a hanging light fixture that uses halogen bulbs comprising the steps of:
(a) removing a light bulb from an Edison-type lampholder socket in the recessed lighting fixture;
(b) installing a screw-in lampholder adapter into the Edison-type lampholder socket;
(c) attaching an electrical plug to the hanging light fixture;
(d) attaching an electronic ballast to a recessed light fixture housing;
(e) inserting the electrical plug into the screw-in lampholder adapter;
(f) attaching a cover plate by suitably engaging at least one spring clip to the housing of the recessed lighting fixture.

10. The method defined by claim 9, wherein the cover plate is engaged with the housing of the recessed lighting fixture by two spring clips suitably attached to the housing of the recessed lighting fixture.
